(19) United States
(12) Patent Application Publication
(10) Pub. No.: US 2015/0174587 A1
(43) Pub. Date: Jun. 25, 2015

(54) Gas Purification Device and System, And Ionic Wind Purifier

(71) Applicant: SUZHOU BEIANG TECHNOLOGY LTD, Suzhou (CN)

(72) Inventors: Zhaofeng Wei, Suzhou (CN); Yan Zhang, Suzhou (CN); Hongyu Ran, Suzhou (CN)

(73) Assignee: SUZHOU BEIANG TECHNOLOGY LTD, Suzhou (CN)

(21) Appl. No.: 14/411,437

(22) PCT Filed: Nov. 11, 2013
(86) PCT No.: PCT/CN2013/086897

§ 371 Date: Dec. 26, 2014

(30) Foreign Application Priority Data
Dec. 28, 2012 (CN) 201210586328.7
Dec. 28, 2012 (CN) 201220742007.7
Dec. 30, 2012 (CN) 201210586386
Dec. 30, 2012 (CN) 201220740298.6

(51) Int. Cl. B03C 3/41; B03C 3/12; B03C 3/86

(52) U.S. Cl. CPC B03C 3/41; B03C 3/86; B03C 3/12; B03C 2201/04

(57) ABSTRACT

Provided are a gas purification device and system. The device comprises a gas purification unit; the gas purification unit comprises at least one ionization electrode, at least one repelling electrode and at least one collector; the at least one repelling electrode is provided with electrical potential in the same direction as the electrical potential of the at least one ionization electrode; in the at least one collector is provided with either zero potential or electrical potential in an opposite direction compared with the electrical potential of the at least one ionization electrode; the at least one repelling electrode is used to push the electrified gas particles ionized by the at least one ionization electrode to the at least one collector. In the present invention, the repelling electrode provided with electrical potential in the same direction as the electrical potential of the ionization electrode pushes the electrified gas particles back to the collector, thus causing some of the electrified gas particles deviating from the collector to be pushed to the collector for adsorption. Therefore, the present invention employs a three-electrode structure to improve the adsorption capacity for particles such as dust, and further improve gas purification efficiency.

### RELATED APPLICATIONS

This application claims the priority for the following items: CN 201220742007.7, which is entitled as A Device and System for Gas Purification and is submitted on Dec. 28, 2012; CN 201220740298.6, which is entitled as An Ionic Air Purifier Achieving the Reduction of Noise and is submitted on Dec. 30, 2012; CN 201210586386.X, which is entitled as An Ionic Air Purifier Achieving the Reduction of Noise and is submitted on Dec. 30, 2012; CN 201210586328.7, which is entitled as A Device and System for Gas Purification and is submitted on Dec. 28, 2012. All the above contents are combined with this application in the form of quote.

### TECHNICAL FIELD

The present invention belongs to the field of air purification, especially relates to the device and system for air purification and ionic air purifier.

### BACKGROUND OF THE INVENTION

Air purification mainly refers to eliminating the dust and other impurities in the air. Please see FIG. 1. Among the existing technology, the structure applied by the common air purification device is bipolar electrode, which includes ionization electrode 101 and grounded collection electrode 102. When the device is under working condition, the ionization electrode will be charged with high voltage to make the dust and other contamination particles that is passing through being charged. Then the charged dust and other contamination particles will be absorbed by the zero potential or the collection electrode with an opposite charge potential, providing for the completion of air purification. However, during the working process of such device, the motion direction of some charged dust and other contamination particles will deviate from the collection electrode or will be left out by the collection electrode, leading to the decreased adsorption efficiency of the collection electrode. In other words, due to the decreased cleaning efficiency of the purification device, dust and other contamination particles will escape into the air and get deposited on the furniture or floor, continuing to cause pollution.

As an energy-saving and silent purifier without fan, the working mechanism of ionic air purifier is to automatically drive the air circulation relying on plasma field to generate sufficient air quantity, achieving ultra-low energy consumption and silent operation. In order to generate sufficient air quantity, the ionization electrode of the ionic air purifier shall be large enough, thus the ionization electrode is formed by one or more than one longer parallel electrode wire(s) in general. Through the air intake, air molecules reach the ionization electrode, the electrode wires on which will form plasma field under high pressure, then the air molecules reaching the ionization electrode will be ionized into charged particles. A mass of charged particles will move under the effect of electric field force, from which the momentum is obtained to form the ionic wind.

However, the electrode wire is too long, so that the electric field force formed by charged particles will also drive the overlong electrode wire to vibrate. Because the length, material and thickness of the electrode wires in uniform electric field are the same, the other electrode wires will easily and irresistibly vibrate once one of them vibrates, that is to say, the resonance will occur easily, causing noise.

There is a method to prevent electrode wires from vibrating among the existing technology, that is, placing a spring at one end of the electrode wire for tensioning. Under the function of the spring, the electrode wires will be pulled very tightly, the result of which is the vibration possibility of the electrode wires can be reduced effectively to prevent them from resonating. Finally the control towards the noise will be realized. However, such method needs the very suitable spring. If the spring force is too large, the electrode wires will be snapped. Meanwhile, the electrode wire has been in a tight state and the electrode wire will be oxidized after long exposure to the plasma field, thus the electrode wire snaps easily at certain time, which will influence the security and stability of the ionic air purifier.

### SUMMARY OF THE INVENTION

The technical matter solved by the present invention is that a device and system for air purification is provided to achieve the improvement of adsorption capacity towards the dust and other contamination particles, and further enhance the purification efficiency of air. In addition, the present invention also provides an ionic air purifier achieving the reduction of the noise to solve the problems that the excessive spring force caused by the spring at one end of the electrode wire will snap the wire and the electrode wire in a tight state for a long time will snap easily, which affects the security and stability of the ionic air purifier.

Therefore, the technical proposal adopted by the present invention to solve the technical matter is as follow:

The present invention provides a device for air purification, which includes an air purification unit. The said unit includes at least one ionization electrode, repulsion electrode and collection electrode;

Among which, the said at-least-one repulsion electrode has the same charge potential as the said at-least-one ionization electrode's potential, and the said at-least-one collection electrode has neutral potential or the potential with the opposite charge of the said at-least-one ionization electrode's potential; the said at-least-one repulsion electrode can be used for pushing the charged air particles having been ionized by the said at-least-one ionization electrode to the said at-least-one collection electrode.

Preferentially, the said air purification unit includes at least one collection electrode, at least one ionization electrode and at least one repulsion electrode.

Preferentially, the said air purification unit includes one collection electrode, one ionization electrode and one repulsion electrode, among which the said collection electrode, repulsion electrode and ionization electrode are parallel to each other, and the said collection electrode faces with the said repulsion electrode.

Preferentially, the said air purification unit includes two collection electrodes that are parallel to and directly facing with each other, at least one ionization electrode and at least one repulsion electrode, and each of the repulsion electrodes in the said at-least-one repulsion electrode is parallel to and directly facing with each other.

Preferentially, the said air purification unit includes two collection electrodes that are parallel to and directly facing with each other, one ionization electrode and one repulsion electrode.

Preferentially, the said air purification unit includes at least three collection electrodes, at least two ionization electrodes and at least two repulsion electrodes. The said three collection electrodes are arranged in the external of at-least-one ionization electrode in the form of circular arc, and at least two repulsion electrodes are arranged among the at-least-three collection electrodes in a parallel form.

Preferentially, the said air purification unit includes multiple air purification units, which are connected in series and/or parallel to each other.

Preferentially, the side of any of the said collection electrode facing with the said ionization electrode is the circular arc-shaped protuberance.

Preferentially, the curvature radius of the said circular arc-shaped protuberance shall be at least 20 times that of the said ionization electrode.

Preferentially, the surface of any of the said repulsion electrode has at least one circular arc-shaped protuberance.

Preferentially, the said ionization electrode is comprised of the array formed by one or more metal filament(s).

Preferentially, the surface of the said metal filament is coated with oxidation catalyst or any other coating with low surface effusion to reduce ozone.

Preferentially, one end of the above-mentioned ionization electrode shall be an acicular form, or the surface of the above mentioned ionization electrode shall be the serration form.

Preferentially, the side of the above-mentioned ionization electrode with its back to the collection electrode is coated with the insulation coating or placed with the contradiction electrode with the electric potential that had the same direction with the electric potential of the above-mentioned ionization electrode.

Preferentially, the intensity of the electric field generated by the above-mentioned ionization electrode shall be greater than 10⁵ V/m.

Preferentially, the above motioned ionization electrode and (or) the above described repulsion electrode shall adopt the solid construction or the hollow-core construction.

Preferentially, all of the above motioned ionization electrode, above described collection electrode and above described repulsion electrode shall adopt the smooth surface.

The invention also provides an air purification system; such air purification system shall include the following items: power supply voltage; at least one detector(s); control unit; measuring circuit; arc trigger electrode; and the air purification device as described above.

Among which:

The power supply voltage is designed to supply the power to the motioned ionization electrode, collection electrode and repulsion electrode within the above described air purification system;

For the at-least-one detector(s) described as above, the design purpose is to measure the air velocity and environmental indicators at the ionization electrode of the above mentioned air purification device as well as the dust loading and ozone concentration at the above mentioned air purification device;

The above mentioned measuring circuit is used to measure the electric current of ionization electrode flowed through the above mentioned air purification device;

The above mentioned arc trigger electrode is used for discharging before the ionization electrode and collection electrode arc under the circumstance that the environmental indicators measured by the above mentioned at-least-one detector(s) are changed;

The above mentioned control unit is applied to control the amount of power supply supplied by the power supply voltage to the ionization electrode, collection electrode and repulsion electrode within the above mentioned air purification device in accordance with the electric current of ionization electrode flowed through the above mentioned air purification device that measured by the measuring circuit as well as the air velocity, environmental indicators, dust loading and ozone concentration measured by the above mentioned at-least-one detector(s).

In addition, the invention provides the ionic air purifier that could realize the reduction of noise, and such purifier includes the ionization electrode and collection module. The above mentioned ionization electrode includes the electrode wire, the rear housing and at least one fixing strap; among which, one end of the above described electrode wire is mounted on the upper side-wall of the foresaid rear housing, the other end of the above described electrode wire is mounted on the lower side-wall of the foresaid rear housing, and the above mentioned fixing strap is set in the foresaid rear housing and rigidly connected with the foresaid electrode wire.

Preferentially, one end of the above mentioned fixing strap shall be fixed at the left side-wall of the foresaid rear housing, the other end of the fixing strap shall be fixed at the right side-wall of the foresaid rear housing; furthermore, the above mentioned fixing strap shall be equipped with the fixing parts whose number is equivalent to the number of the whole electrode wires in the foresaid ionic air purifier, and each of the above mentioned fixing parts shall be rigidly connected with the foresaid electrode wire.

Preferentially, the number of the above mentioned fixing straps shall be greater than one (one is included).

Preferentially, the above mentioned purifier includes several fixing straps, one end of each foresaid fixing strap shall be fixed in the rear housing that located on one side of the above mentioned electrode wire, and the other end of the foresaid fixing strap shall be fixed in the rear housing that located on the other side of the above mentioned electrode wire; furthermore, each foresaid fixing strap shall be set with a fixing part, and such fixing part shall be rigidly connected with the foresaid electrode wire.

Preferentially, the foresaid several fixing straps shall be arranged at the above mentioned rear housing in the straight line, curve and interval forms.

Preferentially, if the foresaid fixing part is the porous type, each electrode wire shall be separately passed through the corresponding hole.

Preferentially, if the foresaid fixing part is the groove shape, each groove shall be attached to the corresponding electrode wire.

Preferentially, if the foresaid fixing part includes the porous and groove designs, such holes and grooves shall be dispersedly spread in the above mentioned fixing straps, passed through the corresponding hole and attached to the corresponding electrode wire.

Preferentially, the foresaid fixing strap shall be crossly winded up onto the above mentioned electrode wires; furthermore, one end of the foresaid fixing straps shall be fixed at the left side-wall of the said rear housing, and the other end of the foresaid fixing straps shall be fixed at the right side-wall of the said rear housing.

Preferentially, the materials of the foresaid fixing straps shall be the high pressure resistant materials, including the plastic catch or the Teflon fabric.

Preferentially, the foresaid collection module shall include the collection electrode and the repulsion electrode.

Preferentially, the foresaid collection electrode shall include the following items:

Electrode plate of the collection electrode;

Connecting plate of collection electrode plate mounted on the foresaid electrode plate of the collection electrode;

Conducting resin coated on the foresaid connecting plate of collection electrode plate;

Silica gel covered on the surface of the foresaid conducting resin.

Preferentially, the foresaid repulsion electrode shall include the following items:

Electrode plate of the repulsion electrode;

Connecting plate of electrode plate of repulsion electrode mounted on the foresaid electrode plate of the repulsion;

Conducting resin coated on the foresaid connecting plate of electrode plate of repulsion electrode;

Silica gel covered on the surface of the foresaid conducting resin.

According to the foresaid technical scheme, the air purification device of this invention at least includes one ionization electrode, one repulsion electrode and one collection electrode. Among which, the collection electrode has a neutral charge potential or the opposite charge potential to that of the potential equipped by the ionization electrode; therefore, the collection electrode is able to adsorb the charged air particles of the ionization in the ionization electrode and push such charged air particles to the collection electrode through the repulsion electrode that is equipped with the electric potential whose direction is equivalent to that of the ionization electrode, so as to enable a portion of discharged air particles whose motion direction deviates from the collection electrode to be pushed to the collection electrode and further to be absorbed. Therefore, this invention improves the adsorption capacity towards the dust and other contamination particles through the three-electrode structure and further develops the purification efficiency of the air.

The ionic air purifier provided by this invention is to realize the reduction of noise includes the ionization electrode and the collection module. Among which, the ionization electrode includes the electrode wire, the rear housing and at least one fixing strap. One end of the electrode wire is mounted on the upper side-wall of the foresaid rear housing, the other end of the electrode wire is mounted on the lower side-wall of the foresaid rear housing, and the fixing strap is set in the foresaid rear housing and rigidly connected with the foresaid electrode wire. In this invention, the fixing strap is rigidly connected with the electrode wire, which has an effect on restraining the vibration generated by the electrode wire; the spring is not required to maintain the tension status of the electrode wire and further restrain the vibration generated by the electrode wire with the help of external forces such as the spring force, which could efficiently solve the electrode wire breakage problem arising from the exaggerated elastic force of the spring and the easy-to-break problem occurred while the electrode wire has being in the tension status, effectively restrain the resonance generated by the electrode wire, realize the control on the noise and guarantee the safety and stability of the ionic air purifier.

### DESCRIPTION OF DRAWINGS

In order to explain the technical scheme included in this invention embodiment more clearly, we will make a brief introduction to the attached drawing required by the description on the embodiment. Obviously, the following described drawings are several embodiments of this invention only, and the general technical staffs are able to obtain other attached drawings in accordance with those drawings without contributing creative works.

FIG. 1 refers to the air purification device using the existing technology;

FIG. 2 refers to the vertical section for the detailed embodiment of the air purification device provided by this invention;

FIG. 3 refers to the vertical section for another detailed embodiment of the air purification device provided by this invention;

FIG. 4 refers to the vertical section for another detailed embodiment of the air purification device provided by this invention;

FIG. 5 refers to the vertical section for another detailed embodiment of the air purification device provided by this invention;

FIG. 6 refers to the vertical section for another detailed embodiment of the air purification device provided by this invention;

FIG. 7 refers to the vertical section of a collection electrode provided by this invention;

FIG. 8 refers to the vertical section of a repulsion electrode provided by this invention;

FIG. 9 refers to the vertical section for another detailed embodiment of the air purification device provided by this invention;

FIG. 10 refers to the vertical section for another detailed embodiment of the air purification device provided by this invention;

FIG. 11 refers to the vertical section for another detailed embodiment of the air purification device provided by this invention;

FIG. 12 refers to the structure diagram of the ionic air purifier provided by this invention that could realize the reduction of noise;

FIG. 13 refers to the structure diagram for the ionization electrode of the ionic air purifier provided by this invention that could realize the reduction of noise;

FIG. 14 refers to the partial enlarged structure diagram for the ionization electrode of the ionic air purifier provided by this invention that could realize the reduction of noise;

FIG. 14a refers to a kind of structure diagram for the fixing strap of the ionic air purifier provided by this invention that could realize the reduction of noise;

FIG. 14b refers to another kind of structure diagram for the fixing strap of the ionic air purifier provided by this invention that could realize the reduction of noise;

FIG. 14c refers to another kind of structure diagram for the fixing strap of the ionic air purifier provided by this invention that could realize the reduction of noise;

FIG. 14d refers to another kind of structure diagram for the fixing strap of the ionic air purifier provided by this invention that could realize the reduction of noise;

FIG. 15 refers to another kind of structure diagram of the ionic air purifier provided by this invention that could realize the reduction of noise;

FIG. 15a refers to a kind of spread pattern for the fixing strap of the ionic air purifier provided by this invention that could realize the reduction of noise;

FIG. 15b refers to another kind of spread pattern for the fixing strap of the ionic air purifier provided by this invention that could realize the reduction of noise;

FIG. 16 refers to another kind of structure diagram of the ionic air purifier provided by this invention that could realize the reduction of noise;

FIG. 17 refers to the structure diagram for the collection module of the ionic air purifier provided by this invention that could realize the reduction of noise;

FIG. 18 refers to the partial enlarged structure diagram for the collection module of the ionic air purifier provided by this invention that could realize the reduction of noise.

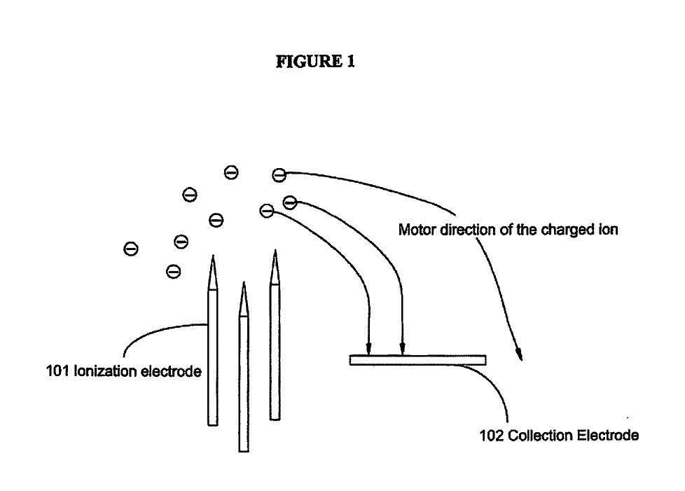

### DETAILED IMPLEMENTATION METHODS

The following section will make a clear and complete description of the technical scheme in this invention embodiment. Obviously, the following described drawings are several embodiments of this invention only rather than the whole embodiments. All the other embodiments obtained by the general technical staffs in this field without contributing any creative works are within the scope protected by this invention.

The air purifier device provided by this invention adopts the three-electrode structure, which is able to push the discharged air particles whose motion direction deviates from the collection electrode back to the collection electrode.

This invention provides a detailed embodiment of the air purifier device. During such embodiment, the foresaid device includes an air purification unit; such air purification unit includes at-least-one ionization electrode, at-least-one repulsion electrode and at-least-one collection electrode. Among which, the said at-least-one repulsion electrode charged electric potential in the same direction of the electric potential charged by the said ionization electrode; one said collection electrode charged zero potential or opposite charged electric potential to one said electric potential charged by the said at-least-one ionization electrode; the said at-least-one repulsion electrode used for pushing the charged air particles which have been ionized by the said at-least-one ionization electrode to one said collection electrode. Here, various collection electrodes, ionization electrodes and repulsion electrodes could be parallel to each other.

According to the foresaid technical scheme, the air purification device in such embodiment at least includes one ionization electrode, one repulsion electrode and one collection electrode. Among which, the collection electrode has the neutral potential or the potential whose direction is opposite to that of the potential equipped by the ionization electrode; therefore, the collection electrode is able to adsorb the charged air particles of the ionization in the ionization electrode and push such charged air particles to the collection electrode through the repulsion electrode that equipped with the electric potential whose direction is equivalent to that of the ionization electrode, so as to enable a portion of discharged air particles whose motion direction deviates from the collection electrode to be pushed to the collection electrode and further to be absorbed, thus improving the adsorption capacity towards the dust and other contamination particles and further developing the purification efficiency of the air.

Here, the foresaid reference to “gas” could be air; in such case, the air purification device is used to purify the air.

Here, the air flow within the air purification device shall be driven by the fan, further entered into the ionization electrode, passed through the collection electrode and discharged from the repulsion electrode. Or, the air flow within the air purification device shall be generated by the momentum acquired by the acceleration of electric field force on airborne particles rather than by any mechanical moving parts; the direction of such air flow is equivalent to that of the electric field force effect, which shall be entered into the ionization electrode, passed through the collection electrode and the repulsion electrode, and further discharged from the air purification device.

Here, it will make the contamination particles such as dusts equipped with the electric potential whose direction is equivalent to that of the ionization electrode, and the electric potential directions refer to the positive direction and negative direction. The ionization electrode can be made from the following items: tungsten; carbon tungsten; tungsten nitride; molybdenum; stainless steel; nickel metal and nickel metal alloy; thermocouple metal and thermocouple alloy; rare metal and rare metal alloy; refractory metal and refractory metal alloy. One end of the ionization electrode could be the acicular form, or the surface of the ionization electrode could be the serration form. Generally speaking, the acicular ionization electrode is the easiest form to implement in technology, and the serration ionization electrode has a better soundness.

Particularly, various foresaid ionization electrodes could be formed by the array constituted by one or several metal wire(s). In the case that the ionization electrode is formed by several metal wires, such metal wires could be parallel to each other. The ionization electrode made by metal wires could generate relatively homogeneous intensity of electric field; furthermore, it is more stable and easy to be controlled. In addition, due to the materials applied, the ionization electrode made by metal wires is easier to get coated with all kinds of coatings in its surface to realize more functions. For example, the surface of the ionization electrode made by metal wires could be coated with the oxidation catalyst coating or the material with low surface overflow capability, so as to reduce the by-product generated by the ionization electrode under the high pressure while generating the plasma, such as the ozone. To take another example, the surface of the ionization electrode made by metal wires could be coated with the oxidation catalyst coating such as the gold, so as to develop the ionic charge density of the ionization in the ionization electrode and further improve the ionization efficiency of the ionization electrode. In addition, the surface of the ionization electrode made by metal wires could also be coated with the oxidation catalyst coating such as the manganese dioxide and the silver, so as to reduce the oxygen constituents and further decrease the ozone generated by the ionization in the ionization electrode. Moreover, the curvature radius of the ionization electrode made by metal wires is usually small; therefore, the ratio between the curvature radius of the collection electrode side that faced with the ionization electrode and that of the ionization becomes greater, reducing the generation of the back electric arc. On the other hand, the metal wires could adopt the high-strength materials such as the tungsten and the stainless steel to meet the strength requirements and extend the service life.

The repulsion electrode and (or) collection electrode could adopt the solid construction or the hollow-core construction. In the case that the repulsion electrode and (or) collection electrode adopts the hollow-core construction, it will reduce the weight of the repulsion electrode and (or) collection electrode for the convenience of transportation and reduce the materials and costs. In the case that the repulsion electrode and (or) collection electrode adopts the solid construction, it will increase the mechanical strength and extend the service life.

The collection electrode usually adopts the plate-type structure with the circular protuberance, such as the rectangle plate and the cylinder plate.

As the air purification device provided by this invention is used under the high-voltage electric field, the accelerating electrode, collection electrode and ionization electrode in this invention usually adopt the smooth surface without any cusp flaw to prevent from generating any electric arc.

In this invention, in order to prevent from generating any invalid ionic ionization, the side of the ionization electrode that faced with the collection electrode could be coated with the electrolyte coating or equipped with the repulsion electrode that had the electric potential whose direction is equivalent to that of the ionization electrode.

In the above mentioned embodiment, the air purification device at least includes one ionization electrode, one repulsion electrode and one collection electrode. In fact, the numbers of the foresaid three electrodes and the positional relations among them have many combining forms, and the following section has given the separate examples in accordance with the numbers of collection electrodes.

First of all, we explain the circumstance that the air purification device provided by this invention only includes one collection electrode.

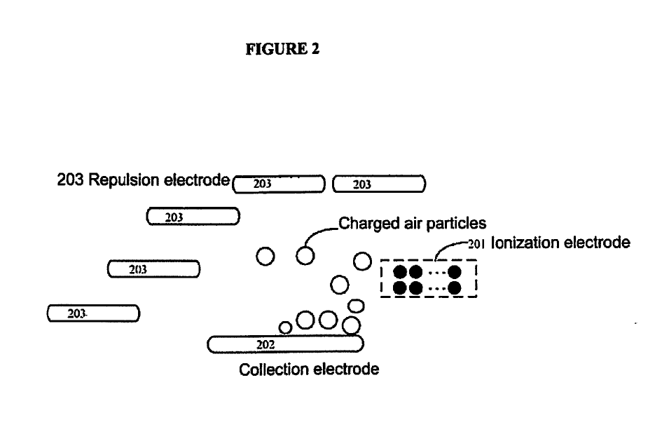

FIG. 2 is a vertical section of air purification device of another embodiment which is provided by this invention. In this embodiment, taking collection electrode as a rectangle plate and each ionization electrode as a metal filament as an example; in other embodiments, the specific structure and composition of collection electrode and ionization electrode are not limited. The said device includes an air purification unit. The said air purification unit includes at-least-one ionization electrode 201, one collection electrode 202 and at-least-one repulsion electrode 203. Among which, the said at-least-one repulsion electrode 203 charged electric potential in the same direction of the electric potential charged by the said ionization electrode 201; one said collection electrode 202 charged zero potential or opposite charged electric potential to one said electric potential charged by the said at-least-one ionization electrode 201; the said at-least-one repulsion electrode 203 used for pushing the charged air particles which have been ionized by the said at-least-one ionization electrode 201 to one said collection electrode 202.

Here, the electric potential direction of each ionization electrode is the same, and each ionization electrode plus high voltage can make dust and other contamination particles charging the electric potential in the same direction of each ionization electrode. The electric potential direction means positive or negative direction of electric potential. For instance, if each ionization electrode has positive electric potential, the collection electrode has the zero potential or negative electric potential and each repulsion electrode has positive electric potential.

In this embodiment, the said at-least-one repulsion electrode 203 in order to push the charged air particles which have been ionized by the said at-least-one ionization electrode 201 to one said collection electrode 202 better, repulsion electrodes in the said at-least-one repulsion electrode 203 are on the same side of collection electrode 202 with the ionization electrodes in the said at-least-one ionization electrode 201, which is on the upper side of the collection electrode 202. In other embodiments, repulsion electrode may not be on the same side of the collection electrode 202 with the ionization electrodes, for example, part or all of the repulsion electrode may on the lower side of collection electrode 202, at this point, such repulsion electrode can be able to push the charged air particles (generally in a small amount) which are on the lower side of collection electrode 202 to collection electrode 202.

In this embodiment, each ionization electrode in at least one ionization electrode 201 can be parallel to the edge line on one side of the said ionization electrode which is faced by the one said collection electrode 202, in other words, in the air purification device shown in FIG. 2, each ionization electrode can be parallel to the right edge line of collection electrode 202.

Particularly, air purification unit in this embodiment can only include one collection electrode, one ionization electrode and one repulsion electrode. Among which, one said collection electrode, one said repulsion electrode and one said ionization electrode are parallel to each other. At that time, the collection electrode can be in the middle of the ionization electrode and the repulsion electrode, or directly facing the repulsion electrode.

In other embodiments, each ionization electrode can be in the upward side of the collection electrode 202. Each repulsion electrode can be in the left and right side of ionization electrode, pushing the charged air particles which have been ionized by the ionization electrode to collection electrode 202.

Moreover, it is going to illustrate the air purification device which is provided by this invention including two different collection electrodes.

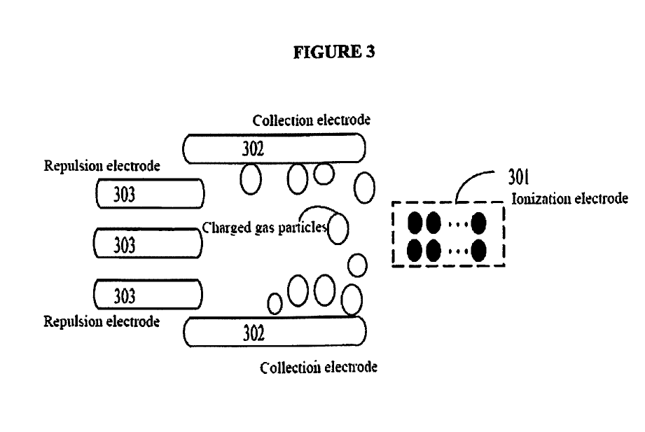

FIG. 3 is a vertical section of air purification device of another embodiment which is provided by this invention. In this embodiment, taking collection electrode as a rectangle plate and each ionization electrode as a metal filament as an example; in other embodiments, the specific structure and composition of collection electrode and ionization electrode are not limited. The said device includes an air purification unit. The said air purification unit includes at-least-one ionization electrode 301, two collection electrode 302 and at-least-one repulsion electrode 303. Among which, the said at-least-one repulsion electrode 303 charged electric potential in the same direction of the electric potential charged by the said ionization electrode 301; two said collection electrode 302 charged zero potential or opposite charge potential to one said electric potential charged by the said at-least-one ionization electrode 301; the said at-least-one repulsion electrode 303 used for pushing the charged air particles which have been ionized by the said at-least-one ionization electrode 301 to the two said collection electrode 302. Among which, at least one repulsion electrode in the repulsion electrode 303 is facing directly and parallel to each other. As the repulsion electrodes are equal in size, overlook the said air purification device, repulsion electrodes are overlapped. Each repulsion electrode can be between the two said collection electrode 302.

Here, each ionization electrode plus high voltage can make dust and other contamination particles charging the electric potential in the same direction of each ionization electrode. The electric potential direction means positive or negative direction of electric potential. For instance, if each ionization electrode has positive electric potential, the two collection electrodes have the zero potential or negative electric potential and each repulsion electrode has positive electric potential.

In this embodiment, the two collection electrodes are parallel to each other and directly facing. The said at-least-one repulsion electrode 303 in order to push the charged air particles which have been ionized by the said at-least-one ionization electrode 301 to the two said collection electrode 302 better, repulsion electrodes in the said at-least-one repulsion electrode 303 and ionization electrodes in the said at-least-one ionization electrode 301 are on the opposite side of any collection electrode center line, the said center line are perpendicular to the collection side of the collection electrode. Specifically, each repulsion electrode can be in the left side of the collection electrode center line, at this point, each ionization electrode is in the right side of the collection electrode 303. And in other embodiments, the repulsion electrode and the ionization electrode may not be in the opposite side of the collection electrode 302, or, part or all collection electrodes can be in the upper or lower side of the collection electrode 302, at this point this repulsion electrode can push the charged air particles (generally in a small amount) which are in the upper or lower side of the collection electrode 302 to collection electrode 302.

In this embodiment, ionization electrodes in at least one ionization electrode 301 can be parallel to the one-sided edge line of the said ionization electrode which is in the face of the two said collection electrode 302, that is, in the air purification as shown in FIG. 3, each ionization electrode can be parallel to the right edge line of collection electrode 302.

In this embodiment, by the two collection electrodes, enlarge the adsorption area and increase the adsorption capacity of dust and other contamination particles, further improve the purification efficiency of the air.

Particularly, air purification unit in this embodiment can only include two collection electrodes, one ionization electrode and one repulsion electrode. It will be specifically illustrated in the following embodiments.

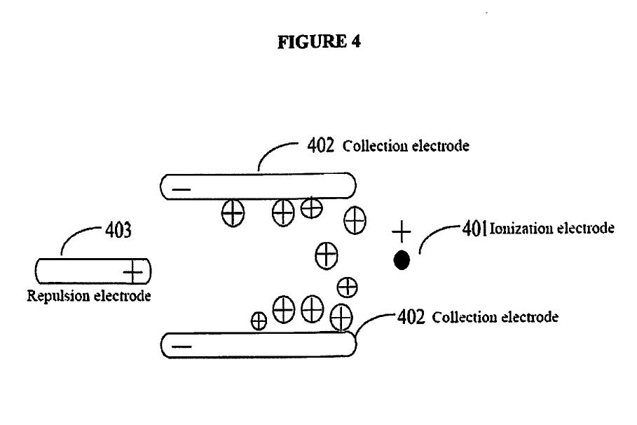

FIG. 4 is a vertical section of air purification device of another embodiment which is provided by this invention. In this embodiment, taking collection electrode as a rectangle plate and ionization electrode as a metal filament as an example; in other embodiments, the specific structure and composition of collection electrode and ionization electrode are not limited. The said device includes an air purification unit. The said air purification unit includes at-least-one ionization electrode 401, two collection electrode 402 and at-least-one repulsion electrode 403. Among which, the said at-least-one repulsion electrode 403 charged electric potential in the same direction of the electric potential charged by the said ionization electrode 401; two said collection electrode 402 charged zero potential or charged electric potential in the opposite direction of one said electric potential charged by the said at-least-one ionization electrode 301; the said at-least-one repulsion electrode 403 used for pushing the charged air particles which have been ionized by the said at-least-one ionization electrode 401 to the two said collection electrode 402. Among which, at least one repulsion electrode in the repulsion electrode 403 is facing directly and parallel to each other. As the repulsion electrodes are equal in size, overlook the said air purification device, repulsion electrodes are overlapped. Each repulsion electrode can be between the two said collection electrode 402.

Here, ionization electrode 401 plus high voltage can make dust and other contamination particles charging the electric potential in the positive direction.

In this embodiment, the two collection electrodes are parallel to each other and directly facing. The one said repulsion electrode 403 and the one said ionization electrode 401 are in the opposite side of the two said collection electrode 402, specifically, the said repulsion electrode can be in the left side of the center line of the collection electrode 402, at this point, the said ionization electrode is in the right side of the collection electrode 402, which means, in the air purification devices as shown in FIG. 4, the right edge line of ionization electrode 401 and the right edge line of collection electrode 402 are parallel.

Finally, it is going to illustrate the air purification device which is provided by this invention including at least three different collection electrodes.

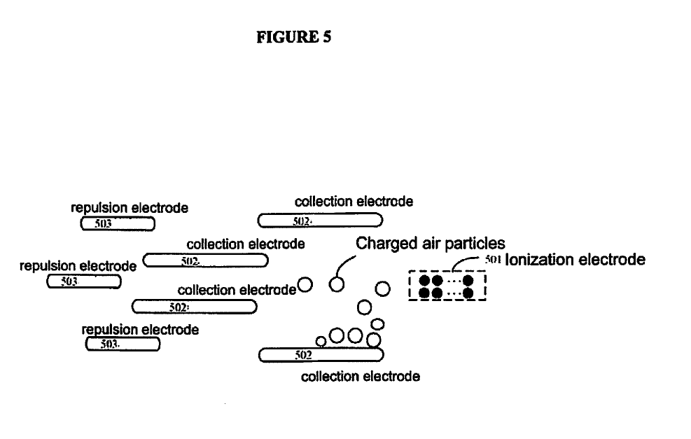

FIG. 5 is a vertical section of air purification device of another embodiment which is provided by this invention. In this embodiment, taking collection electrode as a rectangle plate and ionization electrode as a metal filament as an example; in other embodiments, the specific structure and composition of collection electrode and ionization electrode are not limited. The said device includes an air purification unit. The said air purification unit includes at-least-one ionization electrode 501, three collection electrode 502 and at-least-one repulsion electrode 503. Among which, the said at-least-one repulsion electrode 503 charged electric potential in the same direction of the electric potential charged by the said at-least-one ionization electrode 501; the said at-least-three collection electrode 502 charged zero potential or opposite charged electric potential to electric potential charged by the said at-least-one ionization electrode 501; the said at-least-one repulsion electrode 503 used for pushing the charged air particles which have been ionized by the said at-least-one ionization electrode 501 to the three said collection electrode 502.

Here, each ionization electrode plus high voltage can make dust and other contamination particles charging the electric potential in the same direction of each ionization electrode. The electric potential direction means positive or negative direction of electric potential. For instance, if each ionization electrode has positive electric potential, the two collection electrodes have the zero potential or negative electric potential and each repulsion electrode has positive electric potential.

In this embodiment, the two collection electrodes are parallel to each other. The said at-least-three collection electrode 502 is arranged as an arc outside the side at-least-one ionization electrode. Here, arranged as an arc means an arc which is able to pass through the centers of all collection electrodes. At the same time, the ionization electrode is in the inner side of the arc. The said at-least-one repulsion electrode 503 in order to push the charged air particles which have been ionized by at least one ionization electrode 501 to the said at-least-three collection electrode 502 better, and each repulsion electrode is in the outer side of each ionization electrode compared to each collection electrode. And in other embodiments, each collection electrode also can be arranged in other shapes to the outer side of the said at-least-one ionization electrode. Part or all repulsion electrodes can be in the upper or lower side of any collection electrode in the collection electrode 502, at this point, this repulsion electrode can push the charged air particles (generally in a small amount) which are in the upper or lower side of the collection electrode 502 to collection electrode 502.

In this embodiment, each ionization electrode in at least one ionization electrode 501 can be parallel to the one-sided edge line of the said ionization electrode which is faced by the one said collection electrode 502, in other words, in the air purification device shown in FIG. 5, each ionization electrode can be parallel to the right edge line of collection electrode 502.

In the embodiment, it needs to pass through three collection electrodes at least in order to increase the adsorption areas of the collection electrodes, improve adsorption capacity of dust and other impurity particles and further increase purification efficiency.

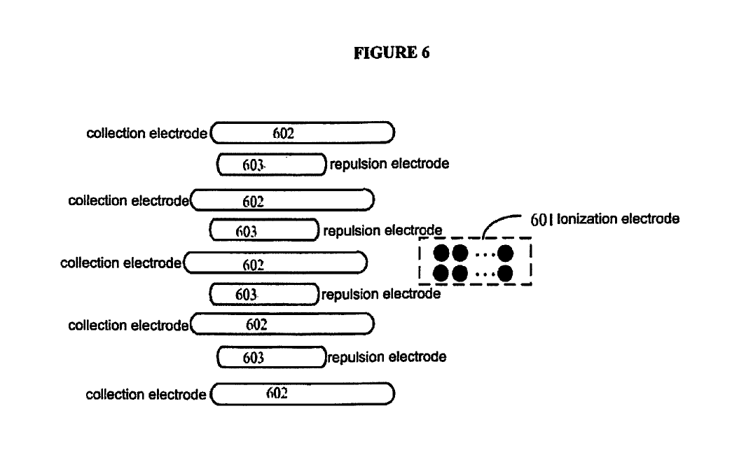

FIG. 6 is the longitudinal section view of air purification device provided in the invention in another specific embodiment. We take the rectangle plate-like collection electrodes and metal ionization electrode for example in the embodiment. In the other embodiment, the specific structure and component of collection electrodes and ionization electrode are unlimited. The device comprises air purification units. The air purification unit includes an ionization electrode 601, three collection electrodes 602 and two repulsion electrodes 603 at least. Electric potential direction of two repulsion electrodes 603 is the same with that of an ionization electrode 601 at least. The electric potential of at least three collection electrodes 602 is zero potential or is opposite to that of an ionization electrode 601 at least. At least two repulsion electrodes 603 send the charged air particles after the ionization of at least one ionization electrode 601 to at least three collection electrodes 602.

Here, after the high voltage is applied to various ionization electrodes, the dust and other impurity particles will have electric potential whose direction is the same with that of various ionization electrodes. The electric potential direction means the positive and negative directions. For example, if the various ionization electrodes have a positive electric potential, the electric potential of various collection electrodes should be zero potential or positive electric potential and the electric potential of each repulsion electrode should be positive electric potential.

In the embodiment, each collection electrode and repulsion electrode is parallel to each other. At least three collection electrodes 602 should be arranged in the external of at least one ionization electrode in the shape of circular arc. At least two repulsion electrodes are parallel arrangement among at least three collection electrodes. The repulsion electrodes are less one than collection electrodes. Meanwhile, there is only one repulsion electrode between two adjacent collection electrodes.

In the embodiment, each ionization electrode in at least one ionization electrode 601 should be parallel to the edge line of one ionization electrode side facing the said two collection electrodes 602, namely, in the air purification device shown in the FIG. 6, each ionization electrode are parallel to right edge line of collection electrodes 602.

In the embodiment of the invention, the number of ionization electrode, collection electrode and repulsion electrode and their position relationship have many kinds of combining forms. They do not include the situations in the above embodiment, but also equivalent transformation made based on the specific structure in the embodiment.

In the embodiment of the invention, preferably, the radius of curvature of one side of collection electrode should be larger than one of ionization electrode. The ionization electrode is consisted of small-radius conductor or semiconductor, which makes ionization electrode more easily produce the high electric field and strong plasma field.

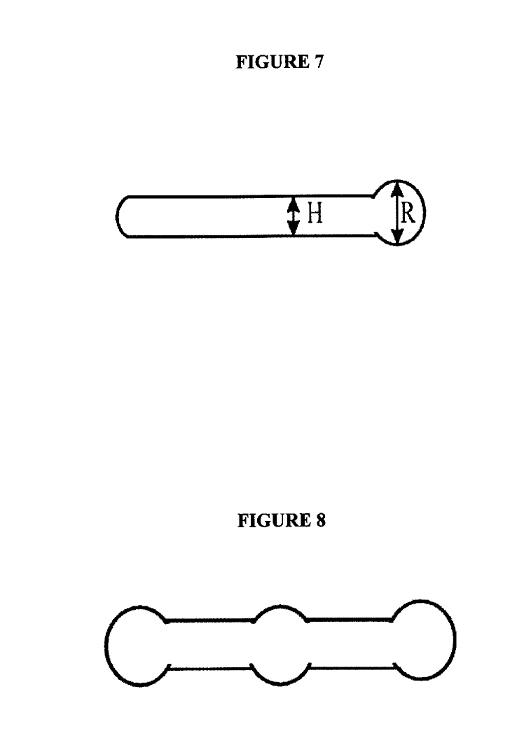

To further optimize the structure of collection electrode, one side of ionization electrode facing to any collection electrode in the invention can be circular arc-shaped protuberance. FIG. 7 is the longitudinal cross section view of collection electrode whose one side is circular arc-shaped protuberance. Here, the circular arc-shaped protuberance is the part that the diameter R of protuberance is larger than thickness H of collection electrode. When one side of ionization electrode facing to collection electrode is circular arc-shaped protuberance, the charged air particles will form turbulent flow moving near the side of ionization electrode facing to collection electrode, so more charged air particles flows toward collection electrode and improve the adsorption efficiency of collection electrode. In addition, the circular arc-shaped protuberance can increase the radius of curvature of one side of ionization electrode facing to collection electrode, so that the radius of curvature of one side of ionization electrode facing to collection electrode is larger than radius of curvature of ionization electrode. Preferably, the radius of curvature of circular arc-shaped protuberance is 20 times larger than that of ionization electrode at least. The larger radius of curvature ratio will cause less electric arc produced on reverse side. In addition, the circular arc-shaped protuberance also improves the surface finish of collection electrode and reduced the electric arc.

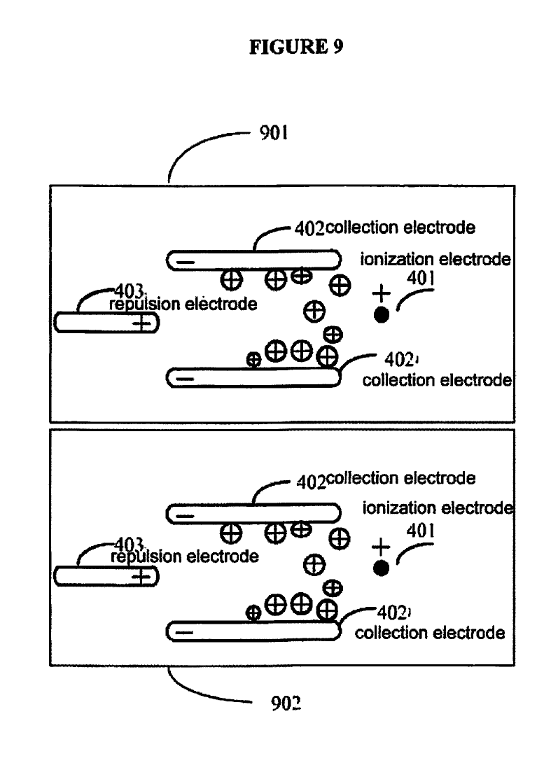

To further optimize the structure of repulsion electrodes there can be a circular arc-shaped protuberance at least on any surface of repulsion electrode. The circular arc-shaped protuberance can be in the side of collection electrode facing to repulsion electrode, the side of collection electrode opposite to repulsion electrode or any position on the surface of collection electrode which it is parallel to. FIG. 8 is the longitudinal cross section view of repulsion electrode with many circular arc-shaped protuberances. Two circular arc-shaped protuberances are separately located in two sides of repulsion electrode. There are two vertically symmetrical circular arc-shaped protuberances in the middle position of repulsion electrode.

The circular arc-shaped protuberances in two sides of repulsion electrode are the ones whose diameters are larger than the thickness of repulsion electrode.

The structural repulsion electrode shown in the FIG. 8 can make the charged particles moving near circular arc-shaped protuberances flow into turbulence and further send more charged particles to collection electrode, improving the absorption efficiency of collection electrode. In addition, the circular arc-shaped protuberances also improve the surface finish of collection electrode and reduced the electric arc.

The above circular arc-shaped protuberances can be produced by aluminum extrusion or molding processing.

There is only one air purification unit in the specific embodiment provided in the invention. In fact, the air purification device provided in the invention can be equipped with many air purification units. And these air purification units are connected in series and/or parallel. This will be explained by three embodiments next. It should be noted that each air purification unit is the one shown in FIG. 4 in the following three embodiments, while the invention does not limit the specific structure of each air purification unit. That is, any air purification unit in the following three embodiments can be ones provided in the invention or ones transformed from its shape.

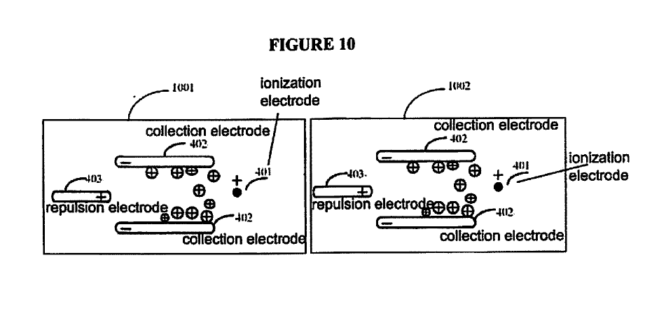

The invention also provides another embodiment of air purification device. FIG. 9 is longitudinal cross section view of air purification device in the embodiment. The air purification device comprises air purification unit 901 and air purification unit 902. The air purification unit 901 and air purification unit 902 are air purification units as shown in FIG. 4. In addition, the air purification unit 901 and air purification unit 902 are connected in series. It means that the collection electrode and repulsion electrode in the air purification unit 901 are respectively parallel to the collection electrode and repulsion electrode in the air purification unit 902 and the air purification unit 902 is below the air purification unit 901. In the embodiment, as the structure of air purification unit 901 is the same with that of air purification unit 902, the ionization electrode and repulsion electrode of air purification unit 902 are below the ones of air purification unit 901 and two collection electrodes of air purification unit 902 are below the two ones of air purification unit 901.

Here, air purification unit 901 and air purification unit 902 are two identical air purification units, so the structure of air purification unit 901 is just introduced here.

The air purification unit 901 comprises: ionization electrode 401 with positive potential, two collection electrodes 402 with negative potential and repulsion electrode 403 with positive potential. The repulsion electrode 403 is used to push the charged air particles after the ionization of ionization electrode 401 to the above two collection electrodes 402.

The dust and impurity particles will have the same potential with each ionization electrode after the high voltage is applied to ionization electrode 401.

Two collection electrodes face each other and are parallel mutually. One repulsion electrode 403 and one ionization electrode 401 are in opposite sides of two collection electrodes 402. Specifically, each repulsion electrode is in left sides of collection electrodes 402 and each ionization electrode is in right sides of collection electrodes 403, that is, the collection electrode 402 is between ionization electrode 401 and repulsion electrode 403. The ionization electrode 401 is parallel to the edge line of one side of two collection electrodes 402 facing to the ionization electrode, that is, the ionization electrode 401 is parallel to the right edge line of collection electrodes 402.

In the other embodiment, the air purification device can include two or more air purification units connected in parallel. And the specific structure and component of air purification unit are unlimited.

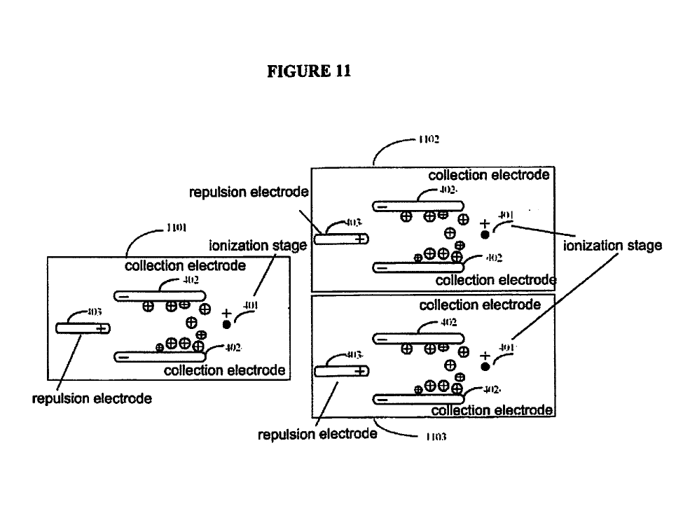

The invention also provides another specific embodiment of air purification device. FIG. 10 is the longitudinal cross section view of air purification device in the specific embodiment.

The air purification device comprises air purification unit 1001 and air purification unit 1002, air purification unit 801 and air purification unit 802 are air purification units shown in FIG. 4. The air purification unit 1001 and air purification unit 1002 are connected together in series. It means that the collection electrode and repulsion electrode in the air purification unit 1001 are are parallel to the collection electrode and repulsion electrode in the air purification unit 1002 and the air purification unit 1001 is below the air purification unit 1002. In the embodiment, as the structure of air purification unit 1001 is the same with that of air purification unit 1002, the collection electrodes on air purification unit 1001 and air purification unit 1002 are on the same level and the collection electrodes below air purification unit 1001 and air purification unit 1002 are also on the same level. The repulsion electrodes of air purification unit 1001 and air purification unit 1002 are on the same level. The ionization electrode of air purification unit 1001 is in one side of ionization electrode of air purification unit 1002 back against the air purification unit 1001.

The air purification unit 1001 and air purification unit 1002 are two identical air purification units, so the structure of air purification unit 1001 is just introduced here.

The air purification unit 1001 comprises: ionization electrode 401 with positive potential, two collection electrodes 402 with negative potential and repulsion electrode 403 with positive potential. The repulsion electrode 403 is used to push the charged air particles after the ionization of ionization electrode 401 to the above two collection electrode 402.

The dust and impurity particles will have the same potential with each ionization electrode after the high voltage is applied to ionization electrode 401.

Two collection electrodes face each other and are parallel mutually. One repulsion electrode 403 and one ionization electrode 401 are in opposite sides of two collection electrodes 402. Specifically, each repulsion electrode is in left sides of collection electrodes 402 and each ionization electrode is in right sides of collection electrodes 403, that is, the collection electrode 402 is between ionization electrode 401 and repulsion electrode 403. The ionization electrode 401 is parallel to the edge line of one side of two collection electrodes 402 facing to the ionization electrode, that is, the ionization electrode 401 is parallel to the right edge line of collection electrodes 402.

In the other embodiment, the air purification device can include two or more air purification units connected in parallel. And the specific structure and component of air purification unit are unlimited.

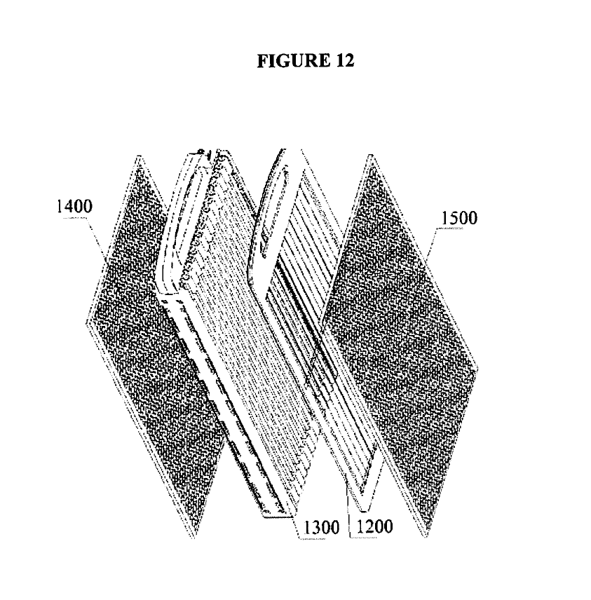

The invention also provides another specific embodiment of air purification device. FIG. 11 is the longitudinal cross section view of air purification device in the specific embodiment. The air purification device comprises air purification unit 1101, air purification unit 1102 and air purification unit 1103. The air purification unit 1101, air purification unit 1102 and air purification unit 1103 are air purification units shown in FIG. 4. The air purification unit 1102 and air purification unit 1103 are connected together in series. This forming series circuit is collected in parallel with air purification unit 1101. The specific structure of air purification unit 1101, air purification unit 1102 and air purification unit 1103 are identical, the specific structure of air purification unit 1101 is only introduced here.

The air purification unit 1101 includes: ionization electrode 401 with positive potential, two collection electrodes 402 with negative potential and repulsion electrode 403 with positive potential. The repulsion electrode 403 is used to push the charged air particles after the ionization of ionization electrode 401 to the above two collection electrode 402.

The dust and impurity particles will have the same potential with each ionization electrode after the high voltage is applied to ionization electrode 401.

Two collection electrodes face each other and are parallel mutually. One repulsion electrode 403 and one ionization electrode 401 are in opposite sides of two collection electrodes 402. Specifically, each repulsion electrode is in left sides of collection electrodes 402 and each ionization electrode is in right sides of collection electrodes 403, that is, the collection electrode 402 is between ionization electrode 401 and repulsion electrode 403. The ionization electrode 401 is parallel to the edge line of one side of two collection electrodes 402 facing to the ionization electrode, that is, the ionization electrode 401 is parallel to the right edge line of collection electrodes 402.

In the other embodiment, the air purification device also comprises more than three serial and parallel air purification units. And the specific structure and composition of air purification unit are unlimited.

The invention also provides a specific embodiment of air purification system. The air purification system includes: supply voltage, pre-detector, rear detector, control unit, measuring circuits, arc trigger electrode as well as any specific embodiment of air purification device.

The supply voltage is used to power the ionization electrode, collection electrode and repulsion electrode.

At least one detector is used to measure the air velocity and environmental index near ionization electrode of air purification device as well as dust concentration and ozone concentration in the place of air purification device. The environmental index includes temperature and humidity, etc.

The measuring circuit is used to measure the current passing through ionization electrode in air purification device. Here, the measuring circuit can perform real-time measurement. In addition, the measuring circuit can use fixed resistance, current converter or hall-effect device to measure the current of ionization electrode.

The arc rigger electrode will earlier discharge than the arc of ionization electrode and collection electrode to reduce voltage or limit current and then protect the air purification device when at least one detector measures the changes in the environmental index.

The control unit is used to control the power value of ionization electrode, collection electrode and repulsion electrode in air purification device based on the current passing through the ionization electrode in air purification device measured by measuring circuit as well as air velocity, environmental index, dust concentration and ozone concentration.

Preferably, the control unit control supply voltage to carry the current to ionization electrode at regular intervals and then the temperature of ionization electrode will be heated to more than 300 degrees Celsius to remove oxide and other impurities. In addition, the control unit can raise the temperature of ionization electrode and collection electrode to accelerate the ozone decomposition rate when the rear detector detect that the ozone concentration is higher than the prescribed value.

One of the main ideas of the invention includes: the electrode wire which is prone to vibration is fixed and connected through fixed belt. The fixed belt can effectively eliminate the vibration of electrode wire, namely it can reduce the sympathetic vibration of electrode wire, control the noise and ensure the safety and stability of ion air purifier.

### One Embodiment

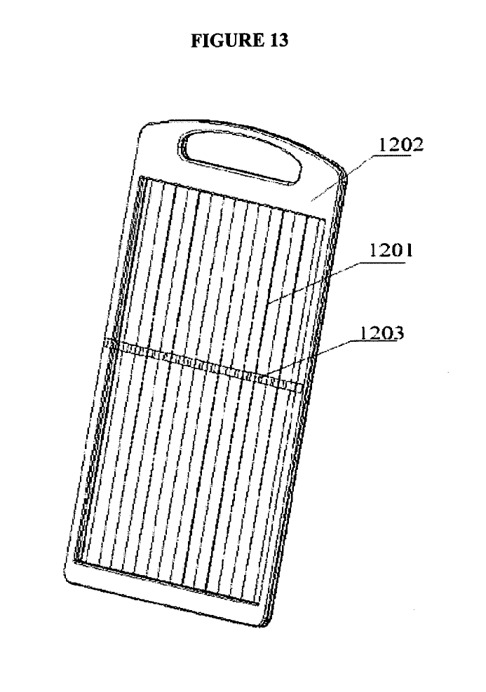

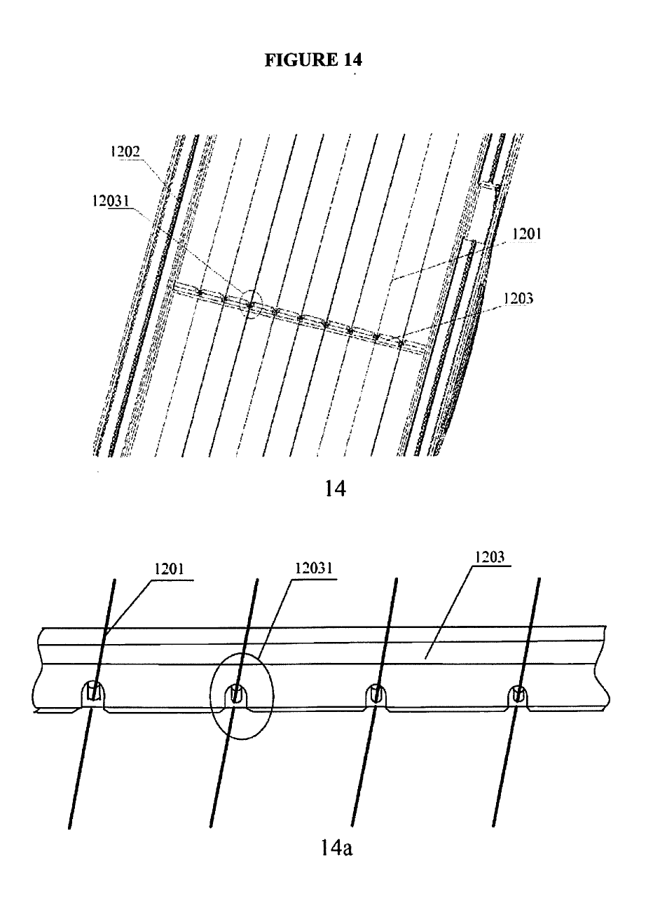

For the structure diagram of ion air purifier reducing noise provided in the invention, please see FIG. 12. It includes: ionization electrode 1200, collect module 1300, air outlet 1400 and air inlet 1500. For the structure diagram of ionization electrode in ion air purifier reducing noise provided in the invention, please see FIG. 13. The ionization electrode 1200 includes electrode wire 1201, rear housing 1202 and at least one fixed belt 1203.

Specifically, one end of electrode wire 1201 is fixed on the upper side wall of rear housing 1202; the other end is fixed on the lower side wall of rear housing 1202. The fixed belt 1203 is set on the rear housing 1202 and connected with electrode wire 1201.

The air flows into the ion air purifier from the air inlet 1500 and then is filtered by the filters in the air inlet 1500 and reaches the ionization electrode 1200. As there are a lot of dust, bacteria and harmful substance, the filter will filtered the large piece of dust out.

Many parallel electrode wires 1201 is arranged on the ionization electrode 1200. The ionization electrode 1200 will form the plasma field under high voltage. Bacteria and other harmful substances will be oxidized to death by high-energy free radicals when they pass through the plasma field. The formaldehyde and macromolecular organic matter in the air are also oxidized and decomposed into water and carbon dioxide by high-energy free radicals at the same time.

It should be noted that the so-called free radicals mean the radical with an unpaired electron. In Chemistry, the electrons in chemical bond have to be paired when atoms form molecules, so free radicals will get an electron from other matter to form the stable matter. This phenomenon is called as free radical oxidation.

Some the air molecules flowing into the plasma field from air inlet 1500 of iron air purifier will be ionized into charged particle. The charged particles are accelerated and collide with other particles to make other particles get the charge under electric field force. Through a series of continuous collision response, most of dust in iron air purifier has charge because they have a collision with charged particles or charged dust particles. At this time, the charged particles and charged dust will move towards the collection module 1300 under electric field force. As the collection module 1300 has the negative electric charges of charged particles, so it can absorb and neutralize the charged particles and dust. In the embodiment, the collection module 1300 comprises collection electrode 1301 and repulsion electrode 1302, among which collection electrode 1300 is used for absorption of charged particles and dust and the repulsion electrode 1302 will send the dust particles incompletely adsorbed by collection electrode 1301 to the collection electrode 1301 to realize the secondary adsorption and improve the collection efficiency of dust, bacteria and others. Finally, the clean air flows out from air outlet 1400 of iron air purifier.

In the above process, a lot of charged particles move and get momentum to form the ion wind under electric field force. The ion wind has an impact on the stability of electrode wire 1201 and makes it vibrate.

In this embodiment, equidistance between every electrode wire 1201 is set as parallel arrangement on the rear housing 1202. Electrode wire 1201 splits with the rear housing 1202; electrode wire appears in suspending state relative to the rear housing; the both ends of electrode wire 1201 are respectively fixed on the upper side wall and below side wall of the rear housing 1202 for tightening electrode wire on the rear housing 1202 against vibration of electrode wire 1201 easily influenced by ionic wind due to looseness. Fixing strap 1203 is set on the rear housing 1202 and fixedly jointed electrode wire for further fixation of polar 1201, restraining vibration of electrode wire 1201 influenced by ionic wind. Therefore, electrode wire 1201 need not utilize spring force and other external force to maintain its tensioning state to restrain vibration of electrode wire 1201, which effectively solves the problems that electrode wire 1201 is snapped by oversize spring force and broken in tensioning state.

Following example specifically explains the fixed relationship between fixing strap 1203 and electrode wire.

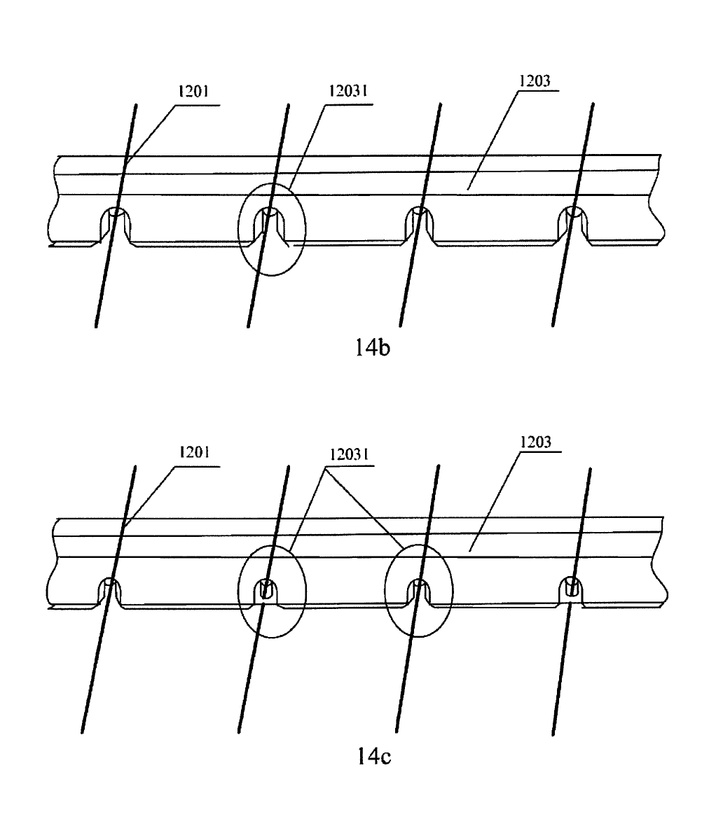

As shown in FIG. 14, it indicates that this invention provide a partial enlarged structural diagram of electrode in an ionic air purifier. Among them, one end of fixing strap 1203 is fixed on left side wall of the rear housing; another end is fixed on right side wall of the rear housing; and fixing strap 1203 is set fixed component 12031 as same number as all electrode wires in the ionic air purifier that each fixed component 12031 fixedly joints one electrode wire 1201.

Fixed component 12031 could be hole, trough or other structure to fix electrode wire 1201. As see in FIG. 14a, it shows that this invention provides a structural diagram of fixing strap in the ionic air purifier. In that diagram, fixed component 12031 is the hole that fixing strap 1203 is set same number of holes with all electrode wire 1201 in the ionic air purifier. Each electrode wire 1201 respectively threads the corresponding hole. This hole can be designed as any kind of round, square, and oval holes etc.

Here, the size of the hole could refer to the diameter of electrode wire 1201. For example, diameter of electrode wire 1201 is 0.1 mm that diameter of the round hole could be designed as 0.5 mm.

The necessary explanation is that: fixing strap 1203 could be set to vertically intersect with extension direction of electrode wire 1201, and also to intersect with extension direction of electrode wire 1201 at included-angle direction. For the paralleled electrode wire with equidistance, it just need set holes on the position of fixing strap in accordance with the position of electrode wire 1201, and make every electrode wire 1201 thread the corresponding hole. At this moment, when it is threading the hole, electrode wire 1201 is fixed by the hole. Electrode wire 1201, fixed by the hole without maintaining tensioning state by spring force and other external force, effectively solves the problems that electrode wire 1201 is snapped by oversize spring force and broken in tensioning state, and restrain resonance of electrode wire.

As shown in FIG. 14b, it shows that this invention provide another structural diagram of fixing strap in an ionic air purifier. Fixed component 12031 is groove. Fixing strap is set same number of grooves with all electrode wire 1201 in the ionic air purifier and each trough is jointed to its corresponding electrode wire 1201. Among them, trough could be designed as groove. The side with pit could be put upward and the side without pit could be set on the rear housing 1202 that groove get directly stuck to electrode wire 1201; or the side with pit could be put downward that get other parts without pit of this side set on the rear housing 1202 and put the side with pit upward to get groove stuck on electrode wire 1201.

Here, designing the size of groove could refer to diameter of electrode wire 1201. For example, diameter of electrode wire is 0.1 mm. For designed groove, depth of groove could be designed as 5 mm and 0.5 mm of width. Certain width of groove could be used for preventing electrode wire slipping off in normal operation.

The necessary explanation is that: fixing strap 1203 could be set to vertically intersect with extension direction of electrode wire 1201, and also to intersect with extension direction of electrode wire 1201 at included-angle direction. For the paralleled electrode wire with equidistance, it just need set holes on the position of fixing strap in accordance with the position of electrode wire 1201, and make every electrode wire 1201 thread the corresponding hole. At this moment, when it is threading the hole, electrode wire 1201 is fixed by the hole. Electrode wire 1201, fixed by the hole without maintaining tensioning state by spring force and other external force, effectively solves the problems that electrode wire 1201 is snapped by oversize spring force and broken in tensioning state, and restrain resonance of electrode wire.

As shown in FIG. 14c, it shows that this invention provide the third structural diagram of fixing strap in an ionic air purifier. In that, fixed component 12031 involves hole and groove, which discretely distribute on the fixing strap 1203. Electrode wire 1201 threads through the corresponding hole, and gets stuck and jointed with corresponding groove.

For example, hole and groove could be designed as interphase setting that could be designed as the sequence of one hole and next one groove from one direction of fixing strap. Certainly, it also could be designed as the sequence of one hole and two grooves. This invention doesn't restrict the form of discrete distribution of hole and groove on fixing strap 1203.

The necessary explanation is that: fixing strap 1203 could be designed on the middle position of electrode wire 1201 based on extension direction of electrode wire 1201. If electrode wire 1201 is too long, multiple fixing straps 1203 could be set on electrode wire 1201. For example, along extension direction of electrode wire 1201, one fixing strap could be set at every 150 mm intervals of electrode wire 120.

Certainly, on the basis of the concept of this invention, many foresaid fixing straps 1203 could be set on ionization electrode 1200 of ionic air purifier. As shown in FIG. 14d, among them, one end of every fixing strap 1203 is fixed on the left side wall of the rear housing 1202; and another end is fixed on the right side wall of the rear housing 1202. And fixing components 12031, as same number as all electrode wires 1201 in ionic air purifier, is set on every fixing strap 1203 that every fixing component 12031 fixes a electrode wire 1201. Specifically, fixing component 12031 could be hole or groove.

The necessary explanation is that: for the position of many fixing strap 1203 on ionization electrode 1200, the position of fixing strap 1203 could be set freely on the basis of practical situation. Interval between the two fixing straps 1203 could be set preferably. For example, along the extension direction of electrode wire 1201, one fixing strap is set on electrode wire 1201 at every interval ranging from 150 mm to 200 mm. It means that interval between two fixing strap 1203 ranges from 150 mm to 200 mm.

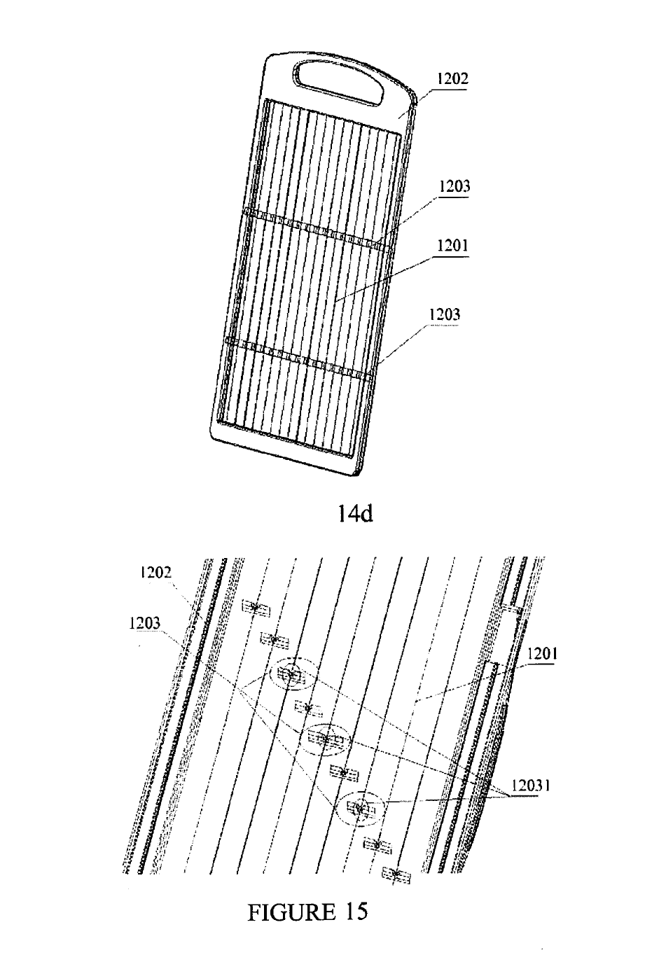

Please refer to FIG. 15, it shows that the invention provides another structure diagram of the ionic air purifier with noise reduction. Among that, ionic air purifier involves multiple fixing straps 1203. One end of every fixing strap 1203 is fixed on one side of the rear housing 1202 of electrode wire 1201; the another end is fixed on the another side of the rear housing 1202; one fixing component 12031 is set on every fixing straps 1203 and fixing component 12031 fixedly joints an electrode wire 1201.

Specifically, in this embodiment, every fixing strap 1203 only is used to fix one electrode wire 1201 and respectively set on the both sides of every electrode wire 1201. Fixing component 12031 on fixing strap 1203 could be hole or groove. The setting mode of fixing component 12031, being hole or groove, is same with setting mode of hole or groove in foresaid embodiment. This embodiment has no more statement about it.

In this embodiment, ionic air purifier involve multiple fixing strap 1203 that multiple fixing strap 1203 is arranged on the rear housing 1202 as straight line, curve, or at intervals. As shown in FIGS. 15a and 15b, in that, FIG. 4a shows that the invention provides array format of fixing strap 1203 in the ionic air purifier with noise reduction that every electrode wire 1201 correspondingly set a fixing strap 1203 and all fixing straps 1203 are arranged on the rear housing 1202 as straight line. All fixing straps 1203 are arranged as straight line and vertically intersect with extension direction of electrode wire 1201. Certainly, all fixing straps 1203 could be designed to arrange as straight line and form a certain angle with extension direction of electrode wire 1201. Moreover, all fixing straps 1203 could be set as S-curve and arranged on the rear housing 1202.

FIG. 15b shows that the invention provides array format of fixing strap 1203 in the ionic air purifier with noise reduction. According to the sequence from the left side of ionization electrode 1200 to the right side of it, fixing strap 1203 is set successively at intervals of electrode wire 1201. Foresaid intervals setting could be as following sequence: the first electrode wire 1201 set fixing strap 1203; the second electrode wire 1201 near the first electrode wire 1201 doesn't set fixing strap 1203; and the third electrode wire 1201 near the second electrode wire 1201 set fixing strap 1203; interval is set between electrode wire 1201 and electrode wire 1201.

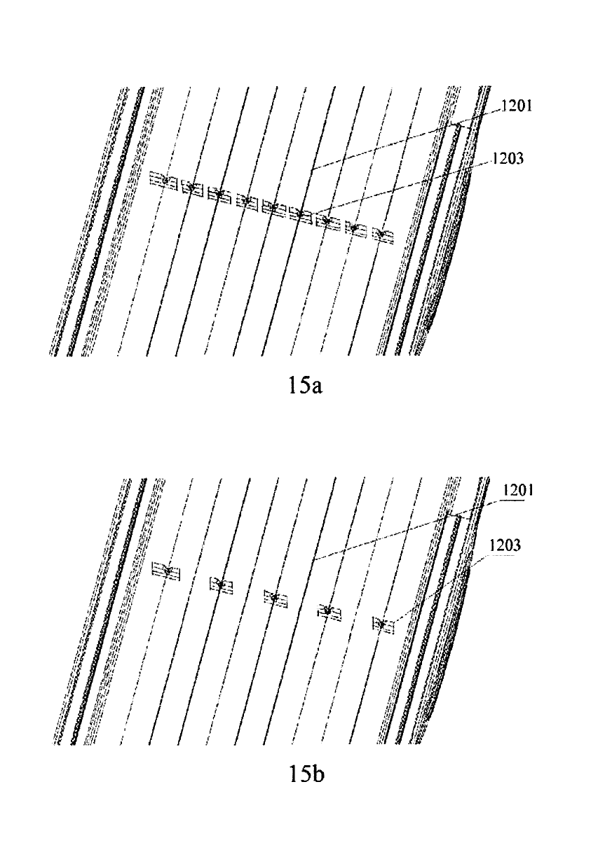

Please refer to FIG. 16, shows that the invention provides extra structure diagram of the ionic air purifier with noise reduction. In that, fixing strap 1203 cross intertwines among electrode wire 1201 and the end of fixing strap 1203 is fixed on the left side wall of the rear housing 1202.

Specifically, fixing strap 1203 evenly winds out of the upper side and underneath of adjacent electrode wire 1201. For example, electrode wire 1201 ranks from the light to the right; for the first electrode wire 1201, fixing strap 1203 winds out of the underneath of the first electrode wire 1201; for the second 1201, fixing strap 1203 winds out of the upper side of the second electrode wire 1201; for the third 1201, fixing strap 1203 winds out of the underneath of the third electrode wire 1201. Fixing strap 1203 fixes every electrode wire 1201 as the pattern that fixing strap 1203 evenly winds out of the upper side and underneath of every electrode wire 1201.

Certainly, fixing strap 1203 could wind out of the upper side of multiple electrode wire 1201, and then wind out of underneath of multiple electrode wire 1201. Multiple fixing straps 1203 could be further set on the rear housing 1202 which could respectively fix electrode wire 1201 by intertwining at different positions along extension direction of electrode wire.

Fixing strap 1203 could evenly wind out of the upper side and underneath of electrode wire 1201 to fix the electrode wire 1201. Therefore, there is no need to set spring to maintain electrode wire 1201 in tensioning state by spring force or external force that could restrain vibration of electrode wire 1201. It could effectively solve the problem of snapping electrode wire by oversize spring force and breaking electrode wire 1201 in tensioning state that could effectively restrain resonance of electrode wire 1201.

In terms of foresaid embodiment, the material of fixing straps 1203 provided by this invention could be material with high pressure resistance, including plastic catch or Teflon fabric. Plastic catch could use fireproof material with V0 fireproof level.

According to application of foresaid technical solution, this invention provides ionic air purifier with noise reduction, including ionization electrode 1200 and collection electrodes 1300. In that, ionization electrode 1200 involves electrode wire 1201, rear housing 1202 and at least one fixing strap 1203. One end of electrode wire 1201 is fixed on the upper side wall of the rear housing 1202; another end of electrode wire 1201 is fixed on the underneath wall of the rear housing 1202; fixing strap 1203 is set on the rear housing 1202 and fixed and jointed to electrode wire 1201. In this invention, fixing strap 1203 is fixed and jointed to electrode wire 1201 that could restrain vibration of electrode wire 1201. Therefore, there is no need to set spring to maintain electrode wire 1201 in tensioning state by spring force or external force that restrain vibration of electrode wire 1201. It could effectively solve the problem of snapping electrode wire by oversize spring force and breaking electrode wire 1201 in tensioning state that could effectively restrain resonance of electrode wire 1201 and control the voice for ensuring operation safety and stability of ionic air purifier.

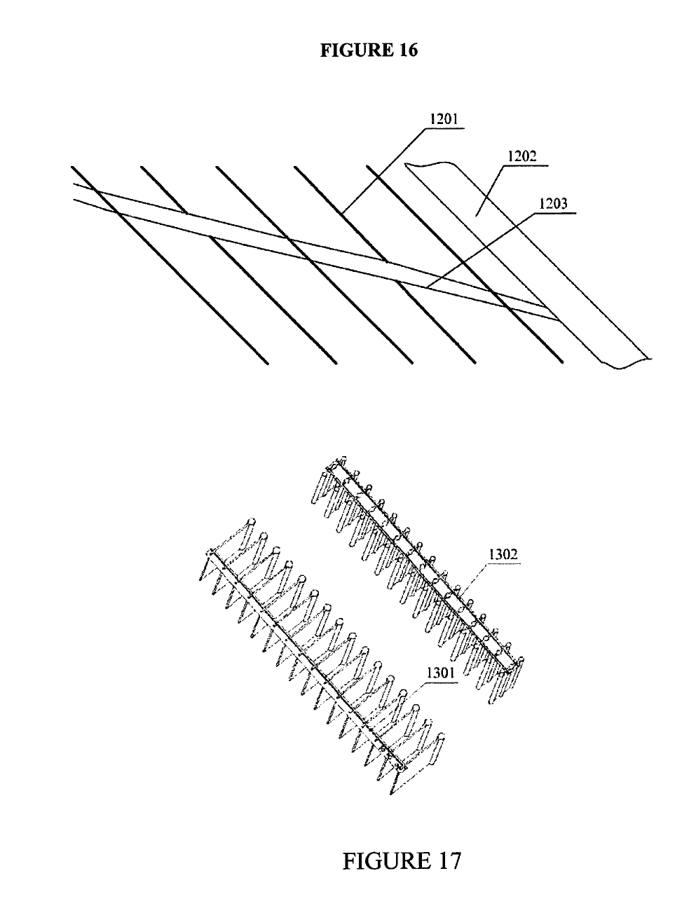

There is another embodiment that collection module 1300 of ionic air purifier include collection electrode 1301 and repulsion electrode 1302. Collection electrode 1301 and repulsion electrode 1302 are all formed by parallel configuration of a series of metal electrode plate. Please refer to FIG. 17, it shows that the invention provides a collection electrode structure diagram of the ionic air purifier with noise reduction. In that, metal electrode plate in collection electrode 1301 and repulsion electrode 1302 utilize connecting plate of metal electrode plate to make every metal electrode plate in collection electrode 1301 and repulsion electrode 1302 respectively connect with corresponding electrode in connecting plate of metal electrode plate. In practical application, collection module 1300 and repulsion electrode 1302 could operate under high pressure condition. If the junction of metal electrode plate and connecting plate of metal electrode plate in collection module 1300 and repulsion electrode 1302 has rosin joint or poor contact etc., joint of collection module 1300 and repulsion electrode 1302 would loosen. Due to junction looseness of collection module 1300 and/or repulsion electrode 1302, collection module 1300 in the ionic air purifier would generate vibration by airflow of air movement and then make noise. The technical solution is stated by invention as following: firstly, joint of metal electrode plate and connecting plate of metal electrode plate in collection module 1300 and repulsion electrode 1302 should be wiped with conducting resin for ensuring stability and reliability of metal electric connection; and then the joint should be wiped with silica gel to further ensure the connective stability of metal electrode plate and connecting plate of metal electrode plate.

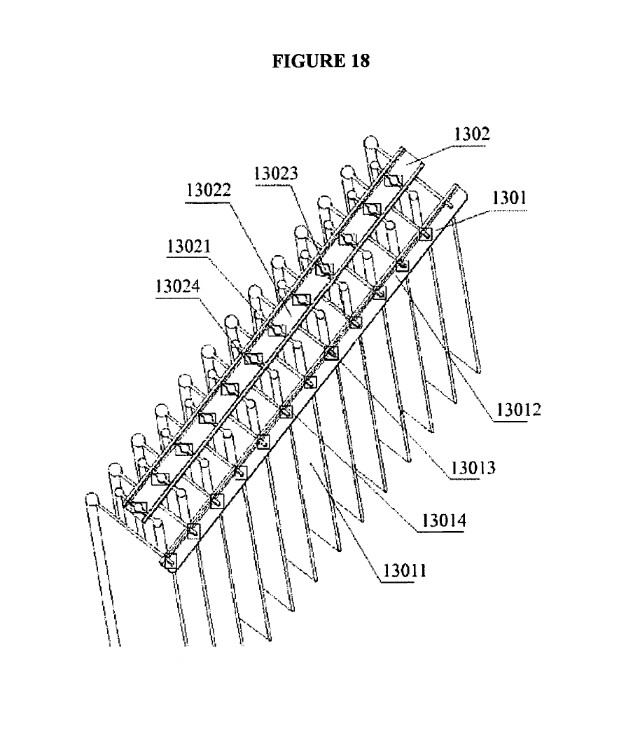

Please refer to FIG. 18, it shows that the invention provides a partial enlarged structure diagram of collection electrode in ionic air purifier with noise reduction. Collection module 1300 includes collection electrode 1301 and repulsion electrode 1302. In that, collection electrode 1301 includes collection electrode electrode plate 13011, connecting plate of collection electrode electrode plate 13012, conducting resin 13013 and silica gel 13014. Repulsion electrode 1302 includes electrode plate of repulsion electrode 13021, connecting plate of electrode plate of repulsion electrode 13022, conducting resin 13023 and silica gel 13024. Specifically, for collection electrode 1301 and repulsion electrode 1302, connecting plate of collection electrode electrode plate 13012 is set on the collection electrode electrode plate 13011 to connect with all corresponding electrode of collection electrode electrode plate 13011 and connecting plate of collection electrode electrode plate 13012 on collection electrode 1301. Connecting plate of electrode plate of repulsion electrode 13022 is set on the electrode plate of repulsion electrode 13021 to connect with all corresponding electrode of connecting plate of collection electrode electrode plate 13021 and connecting plate of electrode plate of repulsion electrode 13022 on repulsion electrode 1302.

In this embodiment, conducting resin 13013 wiped on connecting plate of collection electrode electrode plate 13012 and conducting resin 13023 on connecting plate of electrode plate of repulsion electrode 13022 are same. Silica gel 13014 covered on conducting resin 13013 and silica gel 13024 on conducting resin 13023 are also same. Certainly, on the basis of the thought of this invention, any conductive or fixed device, which could accomplish the goal of this invention, are all under the protection range of this invention.

The necessary statement is that: for convenience of foresaid statement, conducting resin 13013 and conducting resin 13023 are all called as conducting resin, and Silica gel 13014 and Silica gel 13024 are all called as Silica gel.

Conducting resin has quite well conductivity. Wiping it on the connecting plate of collection electrode electrode plate 13012 and connecting plate of electrode plate of repulsion electrode 13022 could be applied to make external aluminum plate joint with connecting plate of collection electrode electrode plate 13012 and connecting plate of electrode plate of repulsion electrode 13022 to power on every electrode plate and ensure the same voltage on every electrode plate.

Silica gel is covered on the surface of conducting resin for ensuring well conductivity of conducting resin and avoiding poor bond or detachment due to overtime conducting resin.

In this embodiment, Silica gel has quite well elasticity that could absorb vibration of collection electrode module 1300 in transportation and using process. Through the dual function of conducting resin and silica gel, joint stability of collection electrode 1301 and repulsion electrode 1302 strengthens, and reduces loosening possibility of collection electrode module 1300 to restrain the noise caused by looseness of collection electrode module 1300.

The necessary statement is that: every embodiment in specification is described as progressive pattern and every embodiment emphasizes its difference with other embodiments; the same and similar aspects of every embodiment could be reference for each other.

Another necessary statement is that: in this article, term “involve”, “contain’ or any other variant of “include” with non-exclusive meaning could make process, method, material of a series of factors not only involve these factors, but also involve other factors without clearly listing or inherent factors in process, method, material or device. Under the circumstance with less restriction, the factor restricted by the sentence “includes one . . . ” don't exclude other existing same factors in foresaid process, method, material or device of factors.

The above aspect makes a detailed introduction of the ionic air purifier with noise reduction provided by this invention. This article use specific example to make statement about principle of this invention and implement mode. Statement of the above embodiment just is applied to help understand the method and core concept of this invention; meanwhile, for general technicists in this area, concrete implement mode and application range would have some changes on the basis of thought of this invention. To sum up, the content of specification should not be considered as the restriction of this invention.

The foresaid is just about preferred implement mode of this invention. It should be pointed out that for general technicists in this area, it still could be improved and embellished without deviating this inventing principles. And these improvement and embellishment should also be involved in protection range of this invention.

1. An air purification device, comprising an air purification unit, wherein said air purification unit comprises at least one ionization electrode, at least one repulsion electrode and at least one collection electrode wherein the said at-least-one repulsion electrode has the potential with the same direction of the said at-least-one ionization electrode potential, and the at-least-one collection electrode has a neutral potential or an opposite charge potential of the at-least-one ionization electrode potential; and the at-least-one repulsion electrode can be used for pushing the charged air particles having been ionized by the at-least-one ionization electrode to the at-least-one collection electrode.

2. (canceled)

3. (canceled)

4. The air purification unit of claim 1, wherein said air purification unit further comprises two collection electrodes that are parallel to each other, at least one ionization electrode and at least one repulsion electrode wherein the at least one repulsion electrode further comprises repulsion electrode plates, and each of the repulsion electrode plate in the said at-least-one repulsion electrode is parallel to each other.

5. (canceled)

6. The air purification unit of claim 1, wherein the said air purification unit comprises at least three collection electrodes, at least two ionization electrodes and at least two repulsion electrodes and wherein the said at least three collection electrodes are arranged external to the at-least-one ionization electrode in the form of circular arc, and at least two repulsion electrodes are arranged among the at-least-three collection electrodes in a parallel form.

7. The air purification device of claim 1 comprising multiple air purification units, which are connected in series and/or parallel to each other.

8. The air purification unit of claim 1 wherein the collection electrode or the repulsion electrode has at least one circular arc-shaped protuberance.

9. The air purification unit of claim 1, wherein the collection electrode facing the ionization state is a circular art-shaped protuberance and the curvature radius of the circular arc-shaped protuberance is at least 20 times that of the ionization electrode.

10. (canceled)

11. The air purification unit of claim 1 wherein the ionization electrode comprises an array formed by one or more metal filament(s).

12. The air purification unit of claim 11, wherein the metal filament is coated with an oxidation catalyst or any other coating with low surface effusion to reduce ozone.

13. (canceled)

14. (canceled)

15. The air purification unit of claim 1 wherein the electric field intensity generated by the ionization electrode is greater than 10⁵ V/m.

16. The air purification unit of claim 1 wherein the ionization electrode comprises an electrode wire, rear housing and at least one fixing strap and wherein one end of the electrode wire is fixed on the upper side wall of the rear housing; and the other end of the electrode wire is fixed on the lower side wall of the rear housing; and the fixing strap is fixed on the rear housing and is used for fixing and connecting the electrode wire.

17. (canceled)

18. The air purification device of claim 1 further comprising a power supply voltage, at least one detector, control unit, measuring circuit, and an arc trigger electrode wherein;
the power supply voltage is used for powering the ionization electrode, collection electrode and repulsion electrode of the air purification device; and
the at-least-one detector is used for measuring the airflow velocity and environment index of the ionization electrode, and the dust and ozone concentration of the air purification device; and
the measuring circuit is used for measuring the current of the ionization electrode flowing through the air purification device; and
the arc trigger electrode shall discharge antecedent to the electric arc of the ionization electrode and collection electrode when the environmental index measured by the at-least-one detector changes; and
the control unit is used for controlling the amount of power supply provided to the ionization electrode, collection electrode and repulsion electrode by the power supply voltage in accordance with the current of the ionization electrode measured by the measuring circuit and the airflow velocity, environmental index, dust and ozone concentration measured by the at-least-one detector.

19. An ionic air purifier comprising a ionization electrode and collection module wherein the ionization electrode comprises an electrode wire, rear housing and at least one fixing strap and wherein one end of the electrode wire is fixed on the upper side wall of the said rear housing; and the other end is fixed on the lower side wall of the said rear housing; and the fixing strap is fixed on the said rear housing and is used for fixing and connecting the said electrode wire.

20. The ionic air purifier of claim 19, wherein one end of the fixing strap is fixed on the left side wall of the rear housing; and the other end is fixed on the right side wall of the rear housing; and the fixing strap is set up with fixing parts whose quantity equals to that of the electrode wire of the ionic air purifier, and each of the fixing parts is connected with an electrode wire fixedly.

21. (canceled)

22. (canceled)

23. The ionic air purifier of claim 19, wherein the fixing straps are arranged on the rear housing in a line or curve or at intervals.

24. The ionic air purifier of claim 19, wherein the fixing part comprises a hole or a groove, and each electrode wire respectively passes through its corresponding hole or groove.

25. (canceled)

26. (canceled)

27. The ionic air purifier of claim 19, wherein the fixing strap crosswise twines around the electrode wire, and one end of the fixing strap is fixed on the left side wall of the said rear housing; and the other end is fixed on the right side wall of the rear housing.

28. The ionic air purifier of claim 19 wherein fixing strap comprises material that is subject to high pressure.

29. The ionic air purifier of claim 19, wherein the collection module comprises collection electrode and repulsion electrode.

30. The ionic air purifier of claim 29, wherein the collection electrode comprises:
electrode plate of the collection electrode; wherein the connecting plate of the electrode plate of the collection electrode is set on the electrode plate of the collection electrode; and
Conducting resin spread on the connecting plate of the electrode plate of the collection electrode; and silica gel covering the surface of the conducting resin.

31. The ionic air purifier of claim 29, wherein the repulsion electrode comprises:
Electrode plate of repulsion electrode; wherein the
connecting plate of the electrode plate of repulsion electrode is set on the electrode plate of repulsion electrode; and
resin spread on the connecting plate of the electrode plate of repulsion electrode; and silica gel covering the surface of the conducting resin.
